(19) United States
(12) Patent Application Publication
(10) Pub. No.: US 2026/0254886 A1
(43) Pub. Date: Aug. 27, 2026

(54) USING QUIC HEADER EXTENSIONS TO EXPOSE UNENCRYPTED APPLICATION LAYER DATA DURING QUIC TRANSPORT

(71) Applicant: QUALCOMM Incorporated, San Diego, CA (US)

(72) Inventors: Liangping Ma, San Diego, CA (US); Imed Bouazizi, Celina, TX (US); Thomas Stockhammer, Bergen (DE); Nikolai Konrad Leung, San Francisco, CA (US); Yih-Hao Lin, San Diego, CA (US); Sitaramanjaneyulu Kanamarlapudi, San Diego, CA (US)

(21) Appl. No.: 19/547,235

(22) Filed: Feb. 23, 2026

Related U.S. Application Data
(60) Provisional application No. 63/764,399, filed on Feb. 27, 2025.

(51) Int. Cl. H04L 69/164; H04L 69/22; H04W 12/037; H04W 76/12

(52) U.S. Cl. CPC H04L 69/164; H04L 69/22; H04W 12/037; H04W 76/12

(57) ABSTRACT

A device for receiving data via a network includes: a memory configured to store data; and a processing system implemented in circuitry and configured to: receive, during a QUIC communication session, a QUIC packet including a QUIC header extension, the QUIC header extension being unencrypted, the QUIC header extension being separate from a set of flags and a connection identifier (ID) of the QUIC packet; extract data from the QUIC header extension; and use the data from the QUIC header extension to receive data of the QUIC communication session.

This application claims the benefit of U.S. Provisional Application No. 63/764,399, filed Feb. 27, 2025, the entire contents of which are incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may be a radio access network (RAN), such as a 5G network. The data may be exchanged using QUIC protocol, e.g., using QUIC packets. In general, QUIC packets, including QUIC header data of the QUIC packets, are mostly encrypted. However, some data of the QUIC packets may be useful for cross-layer optimizations when exchanging QUIC packets via the RAN. Thus, per techniques of this disclosure, one or more unencrypted QUIC header extensions may be added to the QUIC packets, which may allow for exposure of relevant data to the network without compromising sensitive data of the QUIC packets. Use of QUIC header extensions may be negotiated, e.g., in-band or out-of-band, and the data may be used by intermediate devices, such as user plane function (UPF) devices and/or base station devices, to improve exchange of the QUIC packets.

In one example, a method of receiving data via a network includes: receiving, during a QUIC communication session, a QUIC packet including a QUIC header extension, the QUIC header extension being unencrypted, the QUIC header extension being separate from a set of flags and a connection identifier (ID) of the QUIC packet; extracting data from the QUIC header extension; and using the data from the QUIC header extension to receive data of the QUIC communication session.

In another example, a device for receiving data via a network includes: means for receiving, during a QUIC communication session, a QUIC packet including a QUIC header extension, the QUIC header extension being unencrypted, the QUIC header extension being separate from a set of flags and a connection identifier (ID) of the QUIC packet; means for extracting data from the QUIC header extension; and means for using the data from the QUIC header extension to receive data of the QUIC communication session.

In another example, a device for receiving data via a network includes: a memory configured to store data; and a processing system implemented in circuitry and configured to: receive, during a QUIC communication session, a QUIC packet including a QUIC header extension, the QUIC header extension being unencrypted, the QUIC header extension being separate from a set of flags and a connection identifier (ID) of the QUIC packet; extract data from the QUIC header extension; and use the data from the QUIC header extension to receive data of the QUIC communication session.

In another example, a method of transmitting data via a network includes: generating, for a QUIC communication session, a QUIC packet including a QUIC header extension, the QUIC header extension being unencrypted, the QUIC header extension being separate from a set of flags and a connection identifier (ID) of the QUIC packet; and sending the QUIC packet via the network.

In another example, a device for transmitting data via a network includes: a memory; and a processing system implemented in circuitry and configured to generate, for a QUIC communication session, a QUIC packet including a QUIC header extension, the QUIC header extension being unencrypted, the QUIC header extension being separate from a set of flags and a connection identifier (ID) of the QUIC packet; and send the QUIC packet via the network.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of network devices that may perform various aspects of the techniques of this disclosure.

FIG. 4 is a conceptual diagram illustrating packet structures for packets sent between various network devices.

FIG. 5 is a conceptual diagram illustrating an example QUIC packet.

FIG. 6 is a call flow diagram illustrating an example method for negotiating use of QUIC header extensions per techniques of this disclosure.

FIG. 7 is a conceptual diagram illustrating an example of use of QUIC packets including QUIC header extensions per techniques of this disclosure.

FIG. 8 is a flowchart illustrating an example method of constructing and sending a QUIC packet including a QUIC header extension per techniques of this disclosure.

FIG. 9 is a flowchart illustrating an example method of receiving a QUIC packet including a QUIC header extension and using data of the QUIC header extension to receive data of a QUIC communication session per techniques of this disclosure.

### DETAILED DESCRIPTION

In general, this disclosure describes techniques for transmitting data via a network, such as a radio access network (RAN). In some techniques, a data burst is defined as a set of multiple protocol data units (PDUs) generated and sent by an application such that there is an idle period between two data bursts. A data burst can include one or more PDU Sets.

While Real-time Transport Protocol (RTP)is often used to transfer media data via a network, another transmission protocol is QUIC, per Iyengar et al., “QUIC: A UDP-Based Multiplexed and Secure Transport,” Internet Engineering Task Force (IETF), RFC 9000, May 2021, available at datatracker.ietf.org/doc/html/rfc9000. This disclosure describes techniques that may be used with QUIC to signal unencrypted application layer information, e.g., in a QUIC header extension. This disclosure recognizes that QUIC is end-to-end encrypted. Thus, this disclosure describes techniques by which unencrypted application layer information may be signaled when using QUIC for transport of, e.g., encoded video data. Per this disclosure, the application layer information may be signaled in an unencrypted manner, where the application layer information may include information that is useful for cross-layer optimizations, such as PDU Set information, burst information (e.g., time between bursts, minimum time between bursts, idle period information, burst size, or the like), or other such information.

In existing RTP-based transport systems, such as those conforming to 3GPP TS 26.522, RTP header extensions without encryption have been utilized to expose information regarding application data to the network for cross-layer optimization. For example, an RTP header extension may be defined for PDU Set marking, allowing network elements to identify PDU Set boundaries and importance. The techniques of this disclosure provide similar capabilities for QUIC transport, addressing the opacity of standard QUIC headers.

In general, QUIC provides fast connection setup, good support for mobility (e.g., using connection migration), mitigation of head-of-line blocking, and native support for encryption (e.g., TLS). However, QUIC packets do not conventionally directly expose application layer information that can be used for cross-layer optimization. Also, QUIC packet headers are generally encrypted except for a few fields, such as a version field, a connection ID, and a spin bit.

For QUIC packets carrying media data of a media communication session, there are techniques for conveying PDU Set information to network devices, such as a user plane function (UPF) device. These techniques generally involve constructing a secure network tunnel between an application server (AS) device and the UPF to send the PDU Set information. For example, the PDU Set information may be sent as encrypted metadata over a Media over QUIC (MoQ) transport. However, this increases system complexity, because an additional connection needs to be established explicitly between the AS device and the UPF device. While this seemingly addresses security concerns (because only the two endpoint devices, the AS device and the UPF device, are trusted), that motivates end-to-end encryption in QUIC, but actually may not, because application information that needs to be protected end-to-end is exposed to a third party (namely, the UPF device) via the tunnel, although the QUIC packet itself does not directly expose this information.

The techniques of this disclosure include a direct solution to the QUIC protocol. In particular, per techniques of this disclosure, QUIC packets may be formed to include QUIC header extensions on top of the conventional QUIC header. These techniques also allow the application to determine whether to use these techniques based on security needs for a given implementation or scenario.

Encrypted transport protocols, including QUIC, secure communications by encrypting payloads and the majority of header fields. This encryption conceals traffic characteristics from intermediate network elements, such as User Plane Functions (UPFs) and base stations. Consequently, network schedulers lack visibility into application-layer information, such as frame types, burst sizes, or playback buffers. The inability to inspect traffic patterns prevents the network from performing cross-layer optimizations, including Quality of Service (QoS) aware scheduling and efficient radio resource allocation. Per techniques of this disclosure, data may be included in QUIC header extensions that are not encrypted when such data is useful to intermediate devices and destination devices (e.g., to schedule reception, disable reception circuitry during periods when no data will be received, and to allocate reception resources) and when such data would be discoverable anyway such that no sensitive information is leaked to the network. In this manner, these techniques may improve communication of data via QUIC without exposing sensitive information to the network.

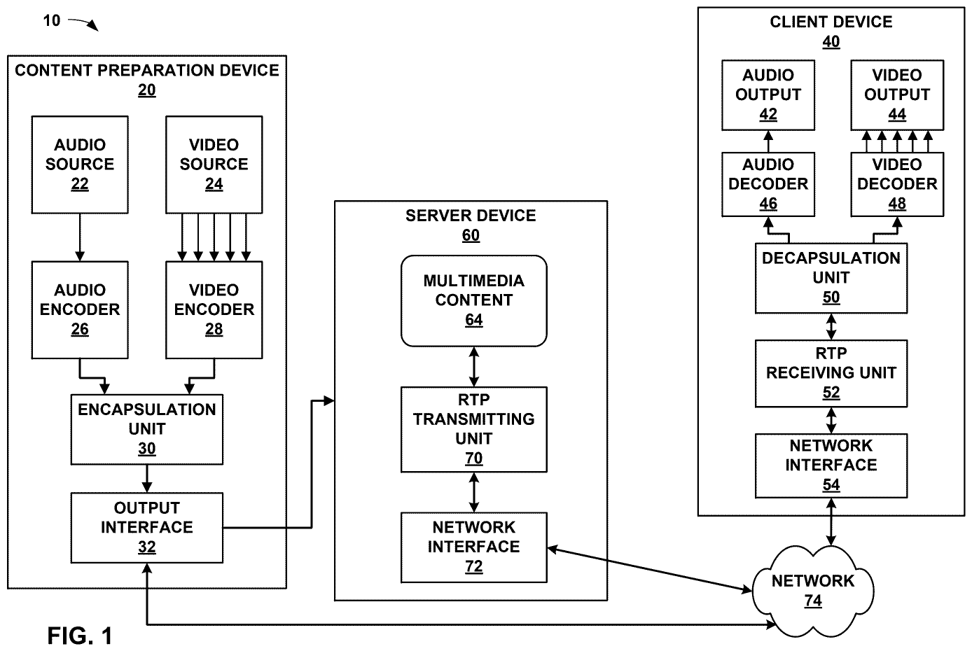

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement User Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Although RTP is explained for purposes of example with respect to FIG. 1, other communication protocols may be used instead of RTP. For example, QUIC may be used to exchange media data between server device 60 and client device 40. Therefore, RTP transmitting unit 70 of server device 60 may alternatively be referred to as a “QUIC transmitting unit,” and RTP receiving unit 52 of client device 40 may alternatively be referred to as a “QUIC receiving unit.” These QUIC transmitting/receiving units may use QUIC instead of, or in addition to, RTP when sending/receiving media data.

In examples utilizing QUIC, server device 60 and client device 40 may establish a QUIC communication session via network 74. Server device 60 may generate and send QUIC packets that include one or more QUIC header extensions. Per the techniques of this disclosure, these QUIC header extensions are unencrypted, unlike the majority of the standard QUIC header (except for flags and connection ID) and the QUIC payload. The unencrypted nature of the QUIC header extension allows intermediate network devices within network 74, which may not possess the keys to decrypt the QUIC header and payload, to access specific application-layer information exposed in the extension.

For instance, network 74 may include a User Plane Function (UPF) device and a Radio Access Network (RAN) base station (e.g., a gNB). When the UPF device receives the QUIC packet, the UPF device may inspect the unencrypted QUIC header extension to extract data, such as Protocol Data Unit (PDU) Set information, burst size, or idle period information. The UPF device may then encapsulate the QUIC packet into a General Packet Radio Service (GPRS) Tunneling Protocol User Plane (GTP-U) packet and include the extracted data in the GTP-U header. Subsequently, the base station receives the GTP-U packet, retrieves the information, and uses the data to perform cross-layer optimizations, such as Quality of Service (QoS) aware scheduling or radio resource allocation for client device 40. Client device 40 may also use the data in the QUIC header extension to adapt reception behavior, such as power saving states based on idle periods.

The QUIC header extension generally includes an extension identifier (ID), an extension length, and the extension data. The extension ID uniquely identifies the type of information carried (e.g., PDU Set info), and the extension length indicates the size of the data. Server device 60 and client device 40 may negotiate the use of these extensions during session establishment, for example, using a QUIC header extension request and response mechanism during the handshake phase or via out-of-band signaling such as Session Description Protocol (SDP).

By utilizing unencrypted QUIC header extensions within system 10, the techniques of this disclosure may enable intermediate network devices within network 74 to access relevant application-layer information without compromising the end-to-end security of the QUIC payload. Access to this information may allow the network to perform cross-layer optimizations, including Quality of Service (QoS) aware scheduling and efficient radio resource allocation, which might otherwise be impossible due to the encryption of standard QUIC headers. Consequently, system 10 may achieve improved application layer performance, potentially resulting in lower latency and higher reliability for media streams exchanged between server device 60 and client device 40.

Furthermore, implementing these techniques directly within the QUIC protocol structure may reduce system complexity compared to alternative solutions that require establishing separate secure tunnels between application servers and network functions to convey similar information. By avoiding the overhead and management of additional tunnels, system 10 may provide a more streamlined and efficient mechanism for exposing traffic characteristics to the network. Additionally, because the application layer determines whether to include these unencrypted extensions, system 10 maintains flexibility, allowing applications to balance the need for network optimization against specific security requirements.

In addition to 5G networks, the techniques implemented by system 10 may provide a generic framework for exposing application layer information that may be applicable to future network generations, such as 6G networks. By establishing a direct mechanism within the transport protocol to convey cross-layer optimization data via network 74, these techniques may support the advanced requirements of next-generation cellular architectures, including lower latency targets and enhanced reliability for real-time communications.

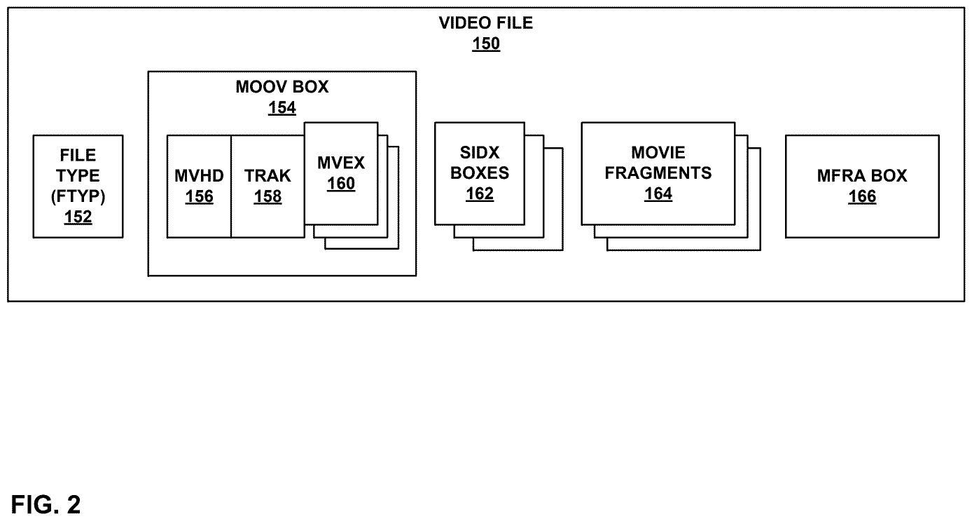

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

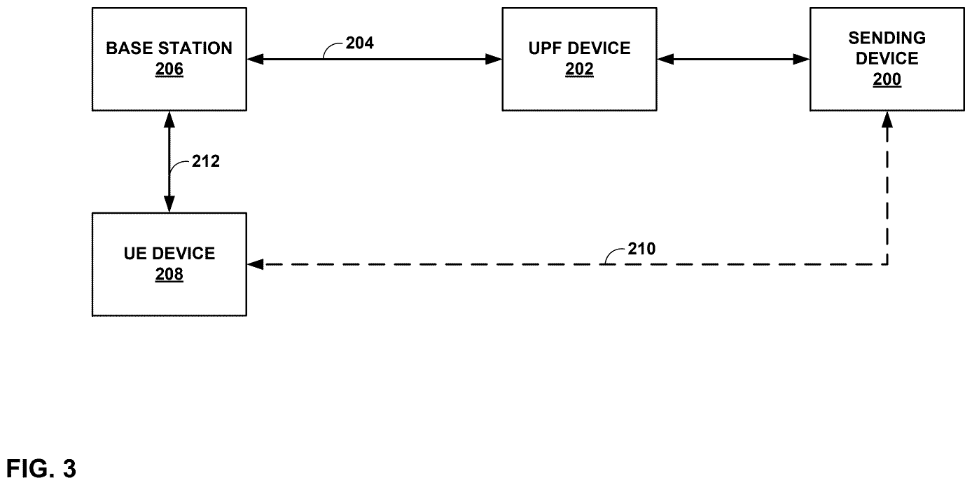

FIG. 3 is a block diagram illustrating an example set of network devices that may perform various aspects of the techniques of this disclosure. The example of FIG. 3 depicts sending device 200, user plane function (UPF) device 202, base station 206, and user equipment (UE) device 208. Sending device 200 may correspond to server device 60 and/or content preparation device 20 of FIG. 1. UE device 208 may correspond to client device 20 of FIG. 1.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form QUIC packets. Sending device 200 may add a QUIC header extension to the QUIC packets, per techniques of this disclosure. The QUIC header extension may include, for example, data representing an idle period indicating a lower bound on a time between a time of transmission of a current QUIC packet and a time of transmission of a subsequent QUIC packet. As the QUIC packets are formed, sending device 200 may send the QUIC packets to UE device 208 via a network including UPF device 202. Although not shown in FIG. 3, there may be additional network devices between sending device 200 and UPF device 202, e.g., various network routing devices, gateways, bridges, switches, or the like.

In some examples, sending device 200 and UE device 208 may negotiate the use of the QUIC header extension. Sending device 200 may indicate support for the QUIC header extension via a Session Description Protocol (SDP) offer message or via transport parameters sent during a handshake phase of communication session 210. Sending device 200 may receive an acknowledgment or confirmation from UE device 208, such as an SDP answer message or response transport parameters. Upon establishing the use of the QUIC header extension, sending device 200 may insert the QUIC header extension into the QUIC packets. The QUIC header extension may include an extension identifier (ID), an extension length, and extension data. The extension data may include the application layer information, such as PDU Set information, burst size, or the idle period.

UPF device 202 may receive the QUIC packets from sending device 200 and form GTP-U tunneled packets. For example, UPF device 202 may encapsulate the QUIC packets with respective GTP-U headers. Per techniques of this disclosure, UPF device 202 may extract the application layer information, e.g., lower bound on the time value, from the QUIC header extensions of the QUIC packets and timestamps indicating times at which the QUIC packets were transmitted by sending device 200, e.g., from respective QUIC header extensions. UPF device 202 may also compare differences between the timestamps to differences between times of reception of the packets to measure network jitter. UPF device 202 may then form the GTP-U headers to include data representing the application layer information, such as a modified idle period time according to the signaled lower bound on the time values and the network jitter. UPF device 202 may send the GTP-U packets to base station 206 via network tunnel 204. Network tunnel 204 may include other network devices, such as network routing devices, configured to forward the GTP-U packets along network tunnel 204 to base station 206. Because the QUIC header extension is unencrypted and separate from the flags and connection ID of the QUIC packet, UPF device 202 may access the application layer information without requiring decryption keys for the QUIC payload or the encrypted portions of the QUIC header.

Base station 206 may receive the GTP-U packets and decapsulate the GTP-U packets to reproduce the QUIC packets. Base station 206 may allocate resources to reception of the GTP-U packets based on the modified idle time period. Base station 206 may then send the QUIC packets to UE device 208 via radio access network (RAN) connection 212. Base station 206 may use the data from the QUIC header extension, such as PDU Set information or burst size, to perform scheduling for UE device 208 or to adapt behavior of UE device 208. For example, base station 206 may configure UE device 208 to enter a sleep state or low power mode during times when no data will be received as part of QUIC communication session 210, but to reenable reception circuitry prior to receipt of data of QUIC communication session 210.

UE device 208 may receive the QUIC packets from base station 206 via RAN connection 212. In particular, UE device 208 may be a battery powered device, such as a cellphone. Thus, to preserve battery power, UE device 208 may disable reception of packets for communication session 210 via RAN connection 212 for idle period times indicated by the lower bound on the time between time of transmission of a previous packet and time of transmission of a subsequent packet of communication session 210. For example, during the idle period times, UE device 208 may power down reception circuitry, then power up the reception circuitry at the end of the idle period.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form QUIC packets. Sending device 200 may add a QUIC header extension to the QUIC packets, per techniques of this disclosure. The QUIC header extension may include, for example, data representing an idle period indicating a lower bound on a time between a time of transmission of a current QUIC packet and a time of transmission of a subsequent QUIC packet. As the QUIC packets are formed, sending device 200 may send the QUIC packets to UE device 208 via a network including UPF device 202. Although not shown in FIG. 3, there may be additional network devices between sending device 200 and UPF device 202, e.g., various network routing devices, gateways, bridges, switches, or the like.

UPF device 202 may receive the QUIC packets from sending device 200 and form GTP-U tunneled packets. For example, UPF device 202 may encapsulate the QUIC packets with respective GTP-U headers. Per techniques of this disclosure, UPF device 202 may extract the application layer information, e.g., lower bound on the time value, from the QUIC header extensions of the QUIC packets and timestamps indicating times at which the QUIC packets were transmitted by sending device 200, e.g., from respective QUIC header extensions. UPF device 202 may also compare differences between the timestamps to differences between times of reception of the packets to measure network jitter. UPF device 202 may then form the GTP-U headers to include data representing the application layer information, such as a modified idle period time according to the signaled lower bound on the time values and the network jitter. UPF device 202 may send the GTP-U packets to base station 206 via network tunnel 204. Network tunnel 204 may include other network devices, such as network routing devices, configured to forward the GTP-U packets along network tunnel 204 to base station 206.

Base station 206 may receive the GTP-U packets and decapsulate the GTP-U packets to reproduce the QUIC packets. Base station 206 may allocate resources to reception of the GTP-U packets based on the modified idle time period. Base station 206 may then send the QUIC packets to UE device 208 via radio access network (RAN) connection 212.

UE device 208 may receive the QUIC packets from base station 206 via RAN connection 212. In particular, UE device 208 may be a battery powered device, such as a cellphone. Thus, to preserve battery power, UE device 208 may disable reception of packets for communication session 210 via RAN connection 212 for idle period times indicated by the lower bound on the time between time of transmission of a previous packet and time of transmission of a subsequent packet of communication session 210. For example, during the idle period times, UE device 208 may power down reception circuitry, then power up the reception circuitry at the end of the idle period.

By incorporating unencrypted QUIC header extensions into the packet structure exchanged between sending device 200 and UE device 208, the system may facilitate cross-layer optimizations that improve network efficiency and user experience. For example, intermediate network elements like UPF device 202 and base station 206 may access traffic characteristics (such as burst sizes or PDU Set boundaries) without needing to decrypt the entire packet payload. This visibility allows base station 206 to perform more intelligent resource scheduling and Quality of Service (QoS) management, potentially increasing throughput and reducing latency for media applications running on UE device 208. Additionally, by exposing idle period information in the unencrypted extension, UE device 208 may optimize its power consumption by transitioning to low-power states during known gaps in transmission, thereby extending battery life.

Furthermore, the disclosed techniques may provide a streamlined alternative to complex tunneling mechanisms often required to convey application-layer metadata through encrypted networks. By directly embedding the metadata in the QUIC header extension, the system avoids the computational and signaling overhead associated with establishing and maintaining separate secure tunnels between the application server and network functions. This approach may not only simplify the network architecture but also may maintain the flexibility of the QUIC protocol, allowing applications to selectively expose only the information necessary for network optimization while keeping sensitive header and payload data secure.

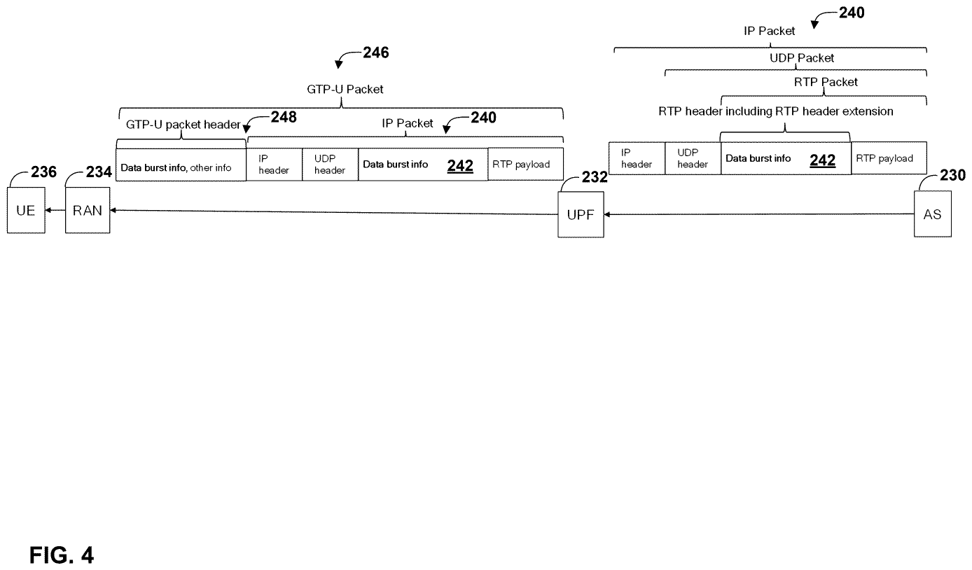

FIG. 4 is a conceptual diagram illustrating packet structures for packets sent between various network devices. For example, FIG. 4 depicts AS device 230, which may correspond to sending device 200 of FIG. 3; UPF device 232, which may correspond to UPF device 202 of FIG. 3; RAN 234, which may include a base station such as base station 206 as shown in FIG. 3 with RAN 212; and UE device 236, which may correspond to UE device 208 of FIG. 3.

Additionally, FIG. 4 depicts IP packet 240 representing an IP packet structure for packets sent by AS device 230 to UPF device 232. In this example, packet 240 encapsulates a UDP packet, which encapsulates an RTP packet including an RTP header and RTP header extension including data burst information 242, and an RTP payload. The RTP packet is encapsulated by a UDP header to form the UDP packet. The UDP packet is encapsulated with an IP header to form IP packet 240.

UPF device 232 encapsulates the IP packet with GTP-U header 248 to form GTP-U packet 246. GTP-U header 248 includes, among other data, data burst information 242 extracted (and potentially modified) from the RTP header and RTP header extension. The base station of the RAN may use the data burst information for scheduling reception of GTP-U packets and to inform UE device 236 as to how to schedule reception of forthcoming packet(s).

The PCF device may determine the Policy and Charging Control (PCC)rules and configure a corresponding session management function (SMF) device. For downlink communications, the SMF device may configure UPF device 232 to identify QUIC packets that carry the QUIC header extensions. For uplink communications, UE device 236 may obtain the protocol description on its own or obtain the protocol description from the SMF device. UPF device 232 and UE device 236 may provide quality of service (QoS) based on the protocol description for the downlink communications and the uplink communications, respectively.

UPF device 232 may identify (based on the protocol description) the QUIC packets with the QUIC header extensions. UPF device 232 may then extract the information in the QUIC header extensions. UPF device 232 may further encapsulate each QUIC packet into a GTP-U packet and add the extracted information in the GTP-U packet header. The base station may use the QUIC header extension data (extracted from the GTP-U packet header) for scheduling and adapting UE behavior.

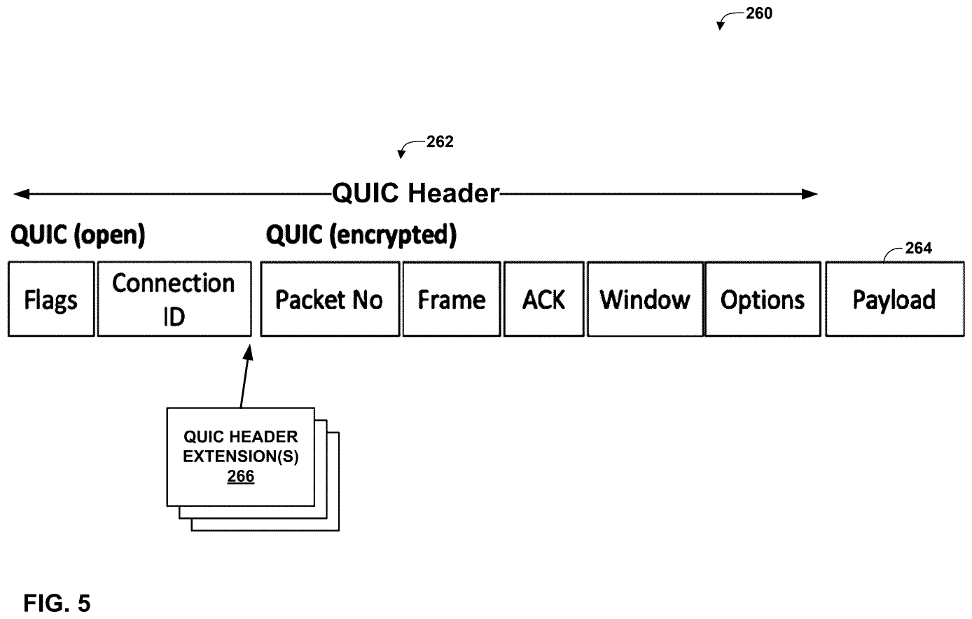

FIG. 5 is a conceptual diagram illustrating an example QUIC packet 260. QUIC packet 260 may be referred to as a “1-RTT QUIC packet.” In some examples, QUIC packet 260 may be formatted as a “Short Header packet,” which is generally used for data transmission after the handshake phase is completed. As shown in FIG. 5, QUIC packet 260 includes unencrypted data (labeled “QUIC (open)”) and encrypted data (labeled “QUIC (encrypted)”). Encrypted data may include, for example, portions of QUIC header 262 and payload 264. As shown in FIG. 5, QUIC header 262 for QUIC packet 260 includes both encrypted and unencrypted data. In QUIC header 262, the flags and Destination Connection ID are unencrypted, as shown in FIG. 5. The flags include only 3 unencrypted bits in a 1-RTT packet format: Header Form (1)=0; Fixed Bit (1)=1; and Spin Bit (1). The spin bit need not be encrypted, because it has been determined that the spin bit does not leak any information to the network.

Per the techniques of this disclosure, one or more QUIC header extensions 266 may be added to the QUIC packet of FIG. 5. Such QUIC header extensions 266 may include unencrypted application layer information that may improve cross-layer efficiency if exposed to the network, e.g., PDU Set information. QUIC header 262 itself may include data indicating the presence of QUIC header extensions 266. For example, QUIC header 262 may include a QUIC version number, where the QUIC version number indicates whether and/or how many QUIC header extensions 266 are present. Additionally or alternatively, QUIC header 262 may include a dedicated indicator that indicates whether one or more QUIC header extensions 266 are included. For example, the dedicated indicator may be one of two reserved bits in the 1-RTT packet header.

A QUIC packet may carry one or more header extensions (e.g., extension elements). Each header extension may include a header and header extension data. The header may include an extension identifier that identifies the type of the header extension in a QUIC connection and an extension length indicating the length of the header extension, e.g., in bytes or other relevant size units (bits, words, etc.) The header extension data may include data or metadata to be communicated to the network transporting the QUIC packet. Multiple extension formats may be used, e.g., a one-byte format including the extension ID and extension length together in one-byte, or a two-byte format including the extension ID and extension length together in two-bytes.

In some examples of the one-byte format, the extension ID and the extension length are each allocated four bits of the single byte (e.g., 4 bits for ID and 4 bits for length). In some examples of the two-byte format, the extension ID and the extension length are each allocated one byte, or may be distributed differently across the sixteen bits (e.g., 8 bits for ID and 8 bits for length, or 4 bits for ID and 12 bits for length).

In some examples, all QUIC header extensions are unencrypted. An application or device receiving the QUIC header extension may determine whether to use unencrypted QUIC header extension information, based on its implementation. In some examples, the QUIC packet header indicates which of the QUIC header extensions are encrypted or not encrypted, e.g., using a bitmap. For example, the bitmap may be an array of bits each corresponding to one of the QUIC header extensions, where a value of 1 for the bit indicates that the QUIC header extension is encrypted and a value of 0 for the bit indicates that the QUIC header extension is unencrypted. In some examples, the QUIC header extension(s) may be ignored by an endpoint that does not support the QUIC header extension(s), and does not change the meaning of the conventional QUIC header fields.

In some examples, a QUIC packet with one or more header extensions may have a format similar to the following format:
1-RTT Packet {
   Header Form (1)=0,
   Fixed Bit (1)=1,
   Spin Bit (1),
   Reserved Bits (2)=10,
   Key Phase (1),
   Packet Number Length (2),
   Destination Connection ID (0 . . . 160),
   Packet Number (8 . . . 32),
   Extension ID (4)=1,
   Extension Length (4)=12,
   Extension data (96),
   Extension ID (4)=2,
   Extension Length (4)=4,
   Extension data (32),
   Packet Payload (8 . . . ),
}

In this example, the format represents a QUIC packet having two QUIC header extensions, indicated by respective extension ID, extension length, and extension data fields. The first QUIC header extension includes an extension ID value of 1 (represented by four bits), an extension length value of 12 (indicating that the extension data field has 12 bytes, i.e., 96 bits) and an extension data field of 96 bits of data. The second QUIC header extension includes an extension ID value of 2, an extension length value of 4 (indicating that the extension data field has 4 bytes, i.e., 32 bits), and an extension data field of 32 bits of data. In the format above, a field is represented by the field name, followed by a value in parentheses (indicating a number of bits for that field), and an optional assigned value for the field indicated by an equals sign followed by the value.

Negotiation of the use of QUIC header extensions may be performed between two endpoint devices, such as between a UE device (e.g., UE device 208 of FIG. 3) and an AS device (e.g., sending device 200 of FIG. 3). In some examples, this negotiation may be performed in-band, where negotiation frames are exchanged during session setup. Negotiation data may be carried in some QUIC packets (e.g., initial packet, handshake packet(s), and/or 1-RTT packet(s)) during the handshake phase. In some examples, two frames are defined and sent as part of the normal payload of the initial packets. The two frames may include a “QUIC header extension request” frame, which carries the header extension IDs and respective definitions of the extensions. The QUIC header extension request frame may be included in the initial packet from the client to the server, where the definition may be indicated by a URL, URI, or URN (which may be registered with IANA). The two frames may also include a “QUIC header extension response” frame, which confirms support for the types of header extensions through indication of the respective header extension IDs, and may be included in the initial packet from the server to the client. Although the two initial packets are encrypted, this encryption generally uses a key derived from a cleartext connection ID and a well-known salt number, such that intermediate routers (e.g., UPF device 202) can inspect the packet(s) and decode the payload (carrying the request/response frames) to determine the meaning of the header extensions.

Alternatively, the two frames may be as indicated above, but the frames need not be encrypted in the QUIC packets (e.g., initial packet, handshake packet, and 1-RTT packet). This may simplify the complexity at intermediate routers (e.g., UPF device 202 of FIG. 3), but may change encryption procedures at QUIC endpoints (e.g., UE device 208 and sending device 200).

Alternatively, transport parameters (declarations that are made unilaterally by each endpoint) may be defined and exchanged in some of the messages during the handshake phase. For example, the client device may indicate via transport parameters supported header extensions, and the server device may reply via transport parameters of the header extensions the server device accepts. In some examples, each transport parameter may contain a header extension ID and a definition of the header extension. That is, each transport parameter may be a 2-tuple. In some examples, one transport parameter may indicate a header extension ID, and a second transport parameter may indicate a definition of the header extension, and the two transport parameters may be used as a pair.

The unencrypted QUIC header extensions may be authenticated, e.g., using an authentication tag (e.g., produced from the AEAD (Authenticated Encryption with Associated Data) algorithm) that confirms the integrity of the QUIC header extensions. This may prevent intermediate entities, such as an on-path attacker (e.g., a rogue router), from tampering with the unencrypted QUIC header extensions.

QUIC header extensions 266 may include unencrypted application layer information that may improve cross-layer efficiency if exposed to the network, e.g., PDU Set information. QUIC header 262 itself may include data indicating the presence of QUIC header extensions 266. For example, QUIC header 262 may include a QUIC version number, where the QUIC version number indicates whether and/or how many QUIC header extensions 266 are present. Additionally or alternatively, QUIC header 262 may include a dedicated indicator that indicates whether one or more QUIC header extensions 266 are included. For example, the dedicated indicator may be one of two reserved bits in the 1-RTT packet header.

QUIC packet 260 may carry one or more header extensions 266 (e.g., extension elements). Each header extension 266 may include a header and header extension data. The header may include an extension identifier that identifies the type of header extension 266 in a QUIC connection and an extension length indicating the length of header extension 266, e.g., in bytes or other relevant size units (bits, words, etc.) The header extension data may include data or metadata to be communicated to the network transporting QUIC packet 260. Multiple extension formats may be used, e.g., a one-byte format including the extension ID and extension length together in one-byte, or a two-byte format including the extension ID and extension length together in two-bytes.

QUIC header extensions 266 may carry various types of data. In some examples, the data includes PDU Set information, such as PDU Set importance, PDU Set sequence number, PDU Set size, or indications of the start or end of a PDU Set. In some examples, the data includes burst information, such as a burst size, a time between bursts, or an idle period. An idle period generally indicates a time duration during which sending device 200 will not transmit data for the QUIC communication session. In some examples, this idle period may be referred to as a “Time To Next Burst” (TTNB) value. To reduce overhead, sending device 200 may be configured to selectively include one or more of these fields (e.g., either the burst size, the TTNB, or both) within the extension data. Sending device 200 may indicate the presence of these specific fields using a presence mask or bitmap included within QUIC header extensions 266. The data may also include delay budget information or other Quality of Service (QoS) parameters.

In some examples, all QUIC header extensions 266 are unencrypted. An application or device receiving QUIC header extension 266 may determine whether to use unencrypted QUIC header extension information, based on its implementation. In some examples, the QUIC packet header indicates which of QUIC header extensions 266 are encrypted or not encrypted, e.g., using a bitmap. For example, the bitmap may be an array of bits each corresponding to one of QUIC header extensions 266, where a value of 1 for the bit indicates that QUIC header extension 266 is encrypted and a value of 0 for the bit indicates that QUIC header extension 266 is unencrypted. In some examples, QUIC header extension(s) 266 may be ignored by an endpoint that does not support QUIC header extension(s) 266, and does not change the meaning of the conventional QUIC header fields.

By structuring QUIC packet 260 to include unencrypted QUIC header extensions 266, the techniques of this disclosure may enable secure yet efficient cross-layer optimization. Because QUIC header extensions 266 are unencrypted and distinct from the encrypted payload 264, network devices may access traffic metadata (such as burst characteristics or PDU Set boundaries) without compromising the confidentiality of the actual media data. Selective exposure allows for improved network resource management, potentially reducing latency and increasing throughput for media applications.

Furthermore, the use of QUIC header extensions 266 may provide a flexible mechanism for signaling application-layer information directly within the transport protocol. Implementation of these extensions may avoid the overhead and architectural complexity associated with out-of-band signaling or encapsulating tunnels solely for metadata transmission. Additionally, the disclosed techniques may further reduce transmission overhead by allowing the application layer to selectively include only specific subsets of available metadata. For example, rather than transmitting a full set of status information in every packet, sending device 200 may choose to include only a “Time To Next Burst” (TTNB) value or a burst size value, depending on the current traffic characteristics. This selective inclusion may reduce the packet size increase associated with the header extensions while still providing the most relevant data for network optimization. Furthermore, by enabling the signaling of idle periods or other timing information within the header extensions, the techniques may facilitate power-saving operations at the receiver, such as UE device 208 of FIG. 3, thereby potentially extending battery life during media streaming sessions.

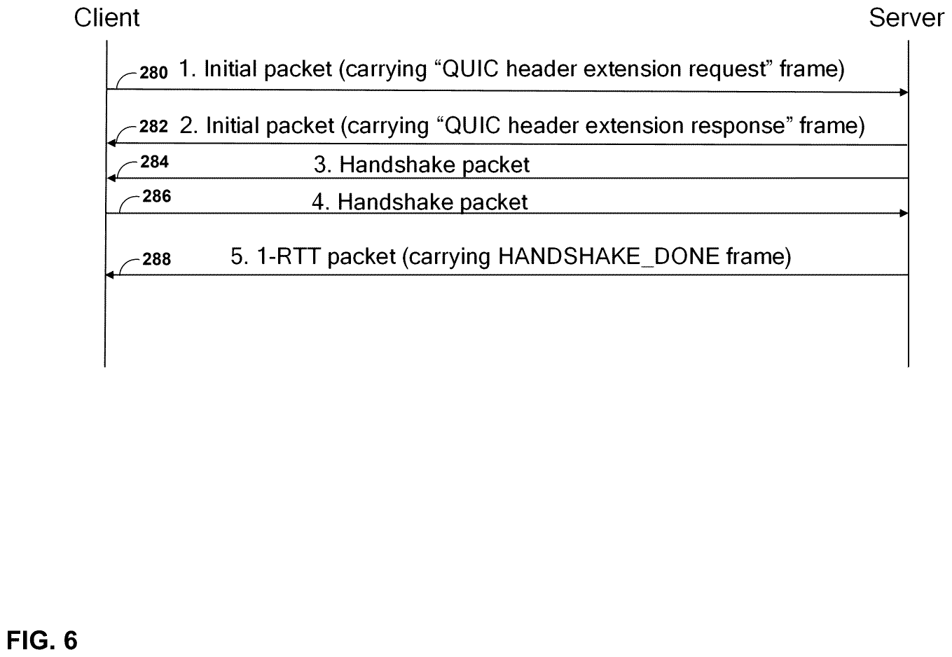

FIG. 6 is a call flow diagram illustrating an example method for negotiating use of QUIC header extensions per techniques of this disclosure. In this example, initially, a client device (e.g., UE device 208 of FIG. 3 or client device 40 of FIG. 1) sends an initial QUIC packet carrying a “QUIC header extension request” frame (280) as discussed above to a server device (e.g., sending device 200 of FIG. 3 or server device 60 of FIG. 1). The initial QUIC packet may include the QUIC header extension request frame including a header extension identifier for the QUIC header extension and a definition of the QUIC header extension.

The server device then responds with an initial packet carrying a “QUIC header extension response” frame (282) as discussed above. This packet may include the QUIC header extension response frame confirming support for the requested QUIC header extension.

In some examples, the negotiation data exchanged via the initial QUIC packet and the initial packet carrying the QUIC header extension response is encrypted according to a key derived from a cleartext connection identifier and a predefined salt number.

The server and client devices then exchange handshake packets (284, 286). The server device then sends a 1-RTT packet carrying a “HANDSHAKE_DONE” frame (288). This may result in QUIC session establishment, and the server device can proceed to send QUIC packets including QUIC header extensions according to the session negotiation, per the techniques of this disclosure. In some examples, exchanging negotiation data includes sending transport parameters indicating the supported and accepted header extensions.

Intermediate devices within the network, such as UPF device 202 and base station 206 (FIG. 3), may use the data in QUIC header extensions 266 to improve transport efficiency. A UPF device may extract the unencrypted data from QUIC header extensions without decrypting the QUIC payload. The UPF device may then encapsulate the QUIC packet into a GTP-U packet and copy the extracted data into a GTP-U header. A base station may receive the GTP-U packet, read the data from the GTP-U header, and perform scheduling or resource allocation based on the data (e.g., allocating resources matching the burst size or PDU Set importance). Additionally, a UE device may use the data, such as the idle period, to perform power saving operations, such as entering a low power state during the idle period.

In some examples, QUIC header extension negotiation may be performed out of band, e.g., using SDP signaling or RTCP packets. SDP Offer and Answer messages may allow the endpoints to negotiate the use of the QUIC header extensions. A first endpoint may send an SDP Offer message containing data indicating supported QUIC header extensions. A second endpoint may then reply with an SDP Answer message containing data indicating its own supported QUIC header extensions, e.g., as a subset of the supported QUIC header extensions of the first endpoint. The two endpoints may then use any of the QUIC header extensions indicated in the SDP Answer message.

The SDP Offer and Answer messages may carry an SDP attribute “quicextmap” including an extension name (e.g., URI, URN, or URL) and extension attributes (e.g., optional configurations). The ABNF syntax may be as follows:
Name: quicextmap
Value: quicextmap-value
Syntax:
   quicextmap−value=mapentry SP extensionname [SP extensionattributes]
   mapentry=“quicextmap:” 1*5DIGIT [“/” direction]
   extensionname=URI
   extensionattributes =byte-string
   direction=“sendonly”/“recvonly”/“sendrecv”/“inactive”
   URI=<Defined in RFC 3986>
   byte-string=<a byte string, defined in RFC 4566>
   SP=<the “space” ASCII character>
   DIGIT=<numbers 0 through 9>

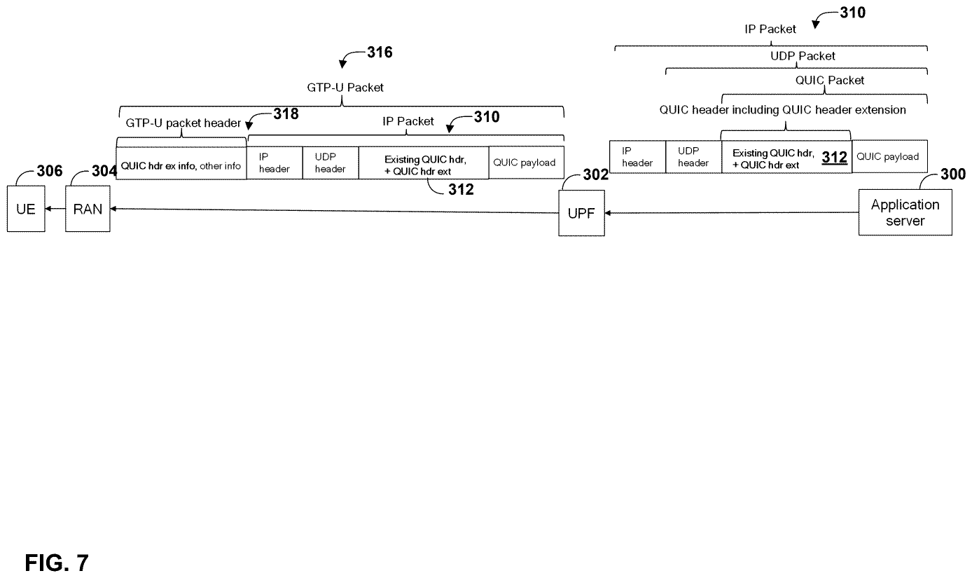

FIG. 7 is a conceptual diagram illustrating an example of use of QUIC packets including QUIC header extensions per techniques of this disclosure. In some examples, an application function (AF) device may extract an agreed setup for QUIC header extensions and send data representing this setup to a policy and charging function (PCF) device as a protocol description. This data may include a protocol (QUIC), type data for the QUIC header extension(s), and QUIC header extension identifier(s).

In particular, FIG. 7 depicts application server (AS) device 300, UPF device 302, RAN 304 including a base station, and UE device 306. AS device 300 may construct IP packet 310 encapsulating a QUIC packet that includes a QUIC header including existing QUIC header and QUIC header extensions 312 per techniques of this disclosure. AS device 300 may implement or function as the application function (AF) described above. Accordingly, AS device 300 may extract the agreed setup for the QUIC header extensions and send the protocol description to a PCF device (not shown in FIG. 7) to configure the network for handling the QUIC header extensions 312.

UPF device 302 may receive IP packet 310 from AS device 300. As described above, the QUIC header extensions are unencrypted, allowing UPF device 302 to access information of the QUIC header extensions without decrypting the payload of the QUIC packet. UPF device 302 may encapsulate IP packet 310 to form a GTP-U packet 316 for a network tunnel to reach RAN 304. GTP-U packet 316 includes GTP-U packet header 318, including data extracted from the QUIC header extension and other GTP-U header information. The base station of RAN 304 may use such data of GTP-U packet header 318 to perform resource allocation and to configure UE device 306, e.g., to enter a low power or sleep mode during times when no data will be received as part of a QUIC communication session, and to enter a receive state when data is expected to be received as part of the QUIC communication session.

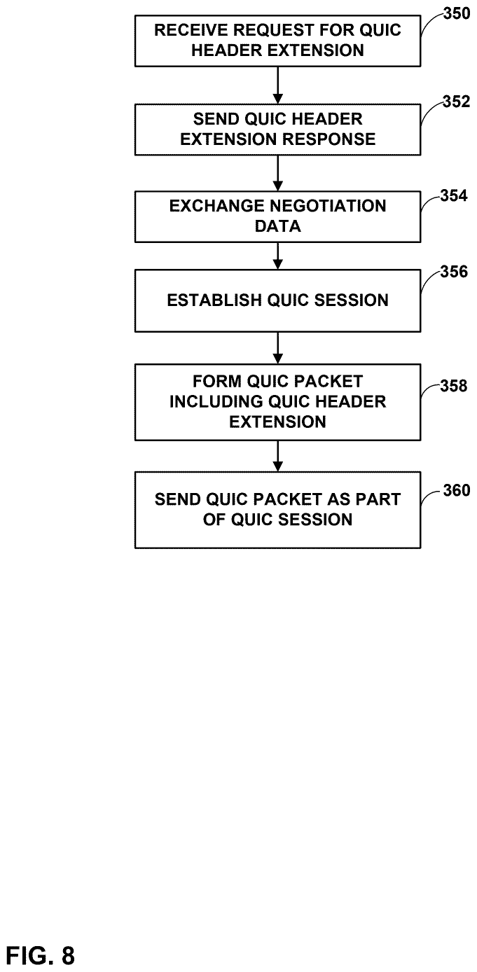

FIG. 8 is a flowchart illustrating an example method of constructing and sending a QUIC packet including a QUIC header extension per techniques of this disclosure. Sending device 200 (FIG. 3), server device 60 (FIG. 1), or AS device 300 (FIG. 7) may perform the method of FIG. 8. Initially, sending device 200 may negotiate the use of QUIC header extensions with a client device, such as UE device 208. In this example, sending device 200 receives a request for a QUIC header extension (350) from UE device 208. For example, sending device 200 may receive an initial QUIC packet including a QUIC header extension request frame. This frame may include a header extension identifier (ID) and a definition of the extension type (e.g., via a URI).

In response, sending device 200 may send a QUIC header extension response (352) to UE device 208. For instance, sending device 200 may send an initial QUIC packet including a response frame confirming support for the requested extension ID. Sending device 200 may also exchange negotiation data (354) with UE device 208. This exchange may include sending and/or receiving transport parameters indicating supported and accepted header extensions during a handshake phase. Alternatively, sending device 200 may perform negotiation out-of-band, such as by sending a Session Description Protocol (SDP) offer message or receiving an SDP answer message containing a ‘quicextmap’attribute.

Sending device 200 establishes the QUIC communication session (356), for example, after completing a handshake and sending a 1-RTT packet carrying a HANDSHAKE_DONE frame. Subsequently, sending device 200 forms a QUIC packet including the QUIC header extension (358). Sending device 200 constructs the QUIC packet to include an unencrypted QUIC header extension separate from the flags and connection ID. Sending device 200 may position the QUIC header extension after a packet number of the QUIC packet and before payload data, e.g., within an unencrypted portion of the QUIC packet header. Sending device 200 may include an extension ID, an extension length, and extension data within the header extension. Sending device 200 may format the length as a single byte (combining ID and length) or two bytes. Sending device 200 may include application layer data in the extension data, such as PDU Set information, burst size, or idle period duration. Sending device 200 may also set an indicator in the QUIC packet to signal the presence of the extension, such as using a specific QUIC version number or setting a reserved bit in the 1-RTT packet header.

Finally, sending device 200 sends the QUIC packet as part of the QUIC session (360). Intermediate devices, such as UPF device 202, may access the unencrypted header extension to facilitate cross-layer optimization, while the payload remains encrypted.

In this manner, the method of FIG. 8 represents an example of a method of transmitting data via a network, including: generating, for a QUIC communication session, a QUIC packet including a QUIC header extension, the QUIC header extension being unencrypted, the QUIC header extension being separate from a set of flags and a connection identifier (ID) of the QUIC packet; and sending the QUIC packet via the network.

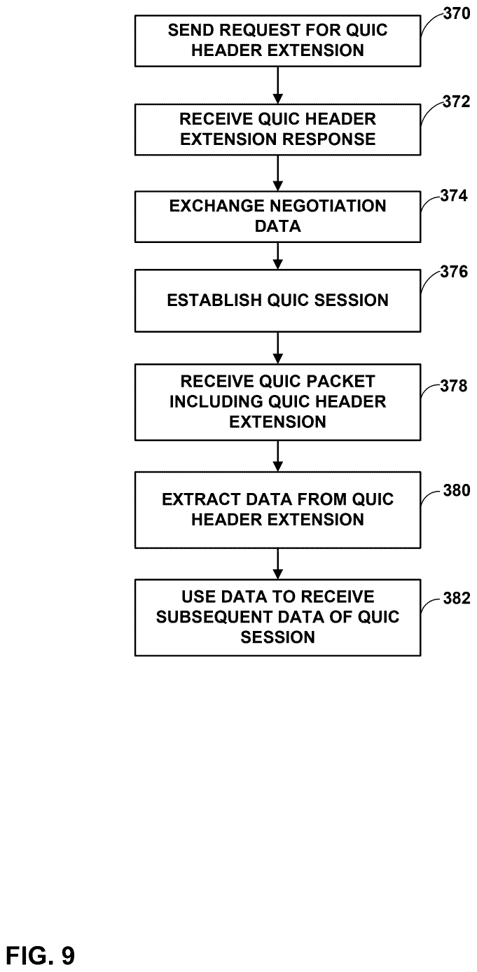

FIG. 9 is a flowchart illustrating an example method of receiving a QUIC packet including a QUIC header extension and using data of the QUIC header extension to receive data of a QUIC communication session per techniques of this disclosure. The method of FIG. 9 may be performed by a destination device, such as UE device 208 (FIG. 3) or client device 40 (FIG. 1). Alternatively, intermediate devices such as UPF device 202 or base station 206 may perform aspects of the method.

Initially, UE device 208 may send a request for a QUIC header extension to be used during a QUIC communication session (370). This step may occur before receiving a QUIC packet carrying media data. UE device 208 may then receive a QUIC packet including a QUIC header extension response (372) confirming support for the QUIC header extension. UE device 208 may further exchange negotiation data (374) with sending device 200 and thus establish a QUIC communication session (376).

In some examples, the negotiation data is encrypted according to a key derived from a cleartext connection identifier and a predefined salt number, or may be unencrypted. In other examples, exchanging the negotiation data includes sending a Session Description Protocol (SDP) offer message indicating support for the QUIC header extension and receiving an SDP answer message confirming support. The negotiation data may include an SDP attribute “quicextmap” including an extension name and extension attributes.

During the QUIC communication session, UE device 208 receives a QUIC packet including a QUIC header extension (378). The QUIC header extension is unencrypted and is separate from a set of flags and a connection identifier (ID) of the QUIC packet. In some examples, the QUIC header extension follows a packet number of the QUIC packet and precedes payload data of the QUIC packet. UE device 208 may determine that the QUIC packet includes the QUIC header extension according to a QUIC version number for the QUIC packet or according to an indicator value included in a set of reserved bits of a 1-RTT packet header of the QUIC packet.

UE device 208 extracts data from the QUIC header extension (380). The QUIC header extension may include an extension identifier (ID), an extension length, and extension data. The extension length may have a value indicating a length of the extension data. In some examples, a single byte of data includes the extension ID and the extension length. In other examples, two bytes of data include the extension ID and the extension length. The QUIC header extension may be one of a plurality of QUIC header extensions of the QUIC packet. One or more of these extensions may be encrypted. Accordingly, the QUIC packet may include data indicating which of the plurality of QUIC header extensions is encrypted or unencrypted.

UE device 208 uses the data from the QUIC header extension to receive data of the QUIC communication session (382). For example, if the data indicates an idle period, UE device 208 may enter a low-power state for the duration of the idle period. If the method is performed by UPF device 202, using the data may involve encapsulating the QUIC packet to form a GTP-U tunneled packet and adding data representing the extracted data to a GTP-U header. If the method is performed by base station 206, using the data may involve performing scheduling for UE device 208 or adapting behavior of UE device 208 using the data.

In this manner, the method of FIG. 9 represents an example of a method of receiving data via a network, including: receiving, during a QUIC communication session, a QUIC packet including a QUIC header extension, the QUIC header extension being unencrypted, the QUIC header extension being separate from a set of flags and a connection identifier (ID) of the QUIC packet; extracting data from the QUIC header extension; and using the data from the QUIC header extension to receive data of the QUIC communication session.

Various examples of the techniques of this disclosure are summarized in the following clauses:

Clause 1. A method of receiving data via a network, the method comprising: receiving, during a QUIC communication session, a QUIC packet including a QUIC header extension, the QUIC header extension being unencrypted; extracting data from the QUIC header extension; and using the data from the QUIC header extension to receive data of the QUIC communication session.

Clause 2. The method of clause 1, wherein the QUIC header extension includes an extension identifier (ID), an extension length, and extension data.

Clause 3. The method of clause 2, wherein the extension length has a value indicating a length of the extension data.

Clause 4. The method of any of clauses 2 and 3, wherein a single byte of data includes the extension ID and the extension length.

Clause 5. The method of any of clauses 2 and 3, wherein two bytes of data include the extension ID and the extension length.

Clause 6. The method of any of clauses 1-5, wherein the QUIC header extension comprises a QUIC header extension of a plurality of QUIC header extensions of the QUIC packet.

Clause 7. The method of clause 6, wherein at least one QUIC header extension of the plurality of QUIC header extensions is encrypted.

Clause 8. The method of any of clauses 6 and 7, wherein the QUIC packet includes data indicating which of the plurality of QUIC header extensions is encrypted or unencrypted.

Clause 9. The method of any of clauses 1-8, further comprising determining that the QUIC packet includes the QUIC header extension according to a QUIC version number for the QUIC packet.

Clause 10. The method of any of clauses 1-8, further comprising determining that the QUIC packet includes the QUIC header extension according to an indicator value of the QUIC packet.

Clause 11. The method of clause 10, wherein the QUIC packet comprises a 1-RTT packet, and the indicator value is included in a set of reserved bits of a 1-RTT packet header of the 1-RTT packet.

Clause 12. The method of any of clauses 1-11, wherein the QUIC header extension follows a packet number of the QUIC packet and precedes payload data of the QUIC packet.

Clause 13. The method of any of clauses 1-12, further comprising exchanging negotiation data representing the QUIC header extension before receiving the QUIC packet.

Clause 14. The method of clause 13, wherein exchanging the negotiation data includes sending an initial QUIC packet including a QUIC header extension request frame including a header extension identifier for the QUIC header extension and a definition of the QUIC header extension.

Clause 15. The method of any of clauses 13 and 14, wherein exchanging the negotiation data includes receiving an initial QUIC packet including a QUIC header extension response frame confirming support for the QUIC header extension.

Clause 16. The method of any of clauses 14 and 15, wherein the negotiation data is encrypted according to a key derived from a cleartext connection identifier and a predefined salt number.

Clause 17. The method of any of clauses 14 and 15, wherein the negotiation data is unencrypted.

Clause 18. The method of clause 13, wherein exchanging the negotiation data includes sending a session description protocol (SDP) offer message indicating support for the QUIC header extension.

Clause 19. The method of any of clauses 13 and 18, wherein exchanging the negotiation data includes receiving a session description protocol (SDP) answer message confirming support for the QUIC header extension.

Clause 20. The method of any of clauses 18 and 19, wherein the negotiation data includes an SDP attribute quicextmap including an extension name and extension attributes.

Clause 21. The method of clause 20, wherein the quicextmap conforms to ABNF syntax of:
Name: quicextmap
Value: quicextmap-value
Syntax:
   quicextmap−value=mapentry SP extensionname [SP extensionattributes]
   mapentry=“quicextmap:” 1*5DIGIT [“/” direction]
   extensionname=URI
   extensionattributes=byte-string direction=“sendonly”/“recvonly”/ “sendrecv”/“inactive”
   URI=<Defined in RFC 3986>
   byte-string =<a byte string, defined in RFC 4566>
   SP=<the “space” ASCII character>
   DIGIT=<numbers 0 through 9>.

Clause 22. The method of any of clauses 1-21, wherein the method is performed by a user plane function (UPF) device, the method further comprising: encapsulating the QUIC packet to form a GTP-U tunneled packet; and adding data representing the extracted data to a GTP-U header of the GTP-U tunneled packet.

Clause 23. The method of any of clauses 1-21, wherein the method is performed by a base station device, and wherein using the data from the QUIC header extension comprises performing scheduling for a user equipment (UE) device or adapting behavior of the UE device using the data from the QUIC header extension.

Clause 24. A device for receiving data via a network, the device comprising one or more means for performing the method of any of clauses 1-23.

Clause 25. The device of clause 24, wherein the one or more means comprise a memory and a processing system implemented in circuitry.

Clause 26. The device of clause 24, wherein the apparatus comprises at least one of: an integrated circuit; a microprocessor; and a wireless communication device.

Clause 27. A device for retrieving media data, the device comprising: means for receiving, during a QUIC communication session, a QUIC packet including a QUIC header extension, the QUIC header extension being unencrypted; means for extracting data from the QUIC header extension; and means for using the data from the QUIC header extension to receive data of the QUIC communication session.

Clause 28. A method of receiving data via a network, the method comprising: receiving, during a QUIC communication session, a QUIC packet including a QUIC header extension, the QUIC header extension being unencrypted, the QUIC header extension being separate from a set of flags and a connection identifier (ID) of the QUIC packet; extracting data from the QUIC header extension; and using the data from the QUIC header extension to receive data of the QUIC communication session.

Clause 29. The method of clause 28, wherein the QUIC header extension includes an extension identifier (ID), an extension length, and extension data.

Clause 30. The method of clause 29, wherein the extension length has a value indicating a length of the extension data, the length being a single byte that includes the extension ID and the extension length.

Clause 31. The method of clause 29, wherein the extension length has a value indicating a length of the extension data, the length being two bytes, the two bytes including the extension ID and the extension length.

Clause 32. The method of any of clauses 28-31, wherein the QUIC header extension comprises a QUIC header extension of a plurality of QUIC header extensions of the QUIC packet.

Clause 33. The method of clause 32, wherein at least one QUIC header extension of the plurality of QUIC header extensions is encrypted, the QUIC packet further including data indicating which of the plurality of QUIC header extensions is encrypted or unencrypted.

Clause 34. The method of any of clauses 28-33, further comprising determining that the QUIC packet includes the QUIC header extension according to a QUIC version number for the QUIC packet.

Clause 35. The method of any of clauses 28-33, further comprising determining that the QUIC packet includes the QUIC header extension according to an indicator value of the QUIC packet, wherein the QUIC packet comprises a 1-RTT packet, and the indicator value is included in a set of reserved bits of a 1-RTT packet header of the 1-RTT packet.

Clause 36. The method of any of clauses 28-35, wherein the QUIC header extension follows a packet number of the QUIC packet and precedes payload data of the QUIC packet.

Clause 37. The method of any of clauses 28-36, further comprising exchanging negotiation data representing the QUIC header extension before receiving the QUIC packet.

Clause 38. The method of clause 37, wherein exchanging the negotiation data includes sending an initial QUIC packet including a QUIC header extension request frame including a header extension identifier for the QUIC header extension and a definition of the QUIC header extension.

Clause 39. The method of any of clauses 37 and 38, wherein exchanging the negotiation data includes receiving an initial QUIC packet including a QUIC header extension response frame confirming support for the QUIC header extension.

Clause 40. The method of any of clauses 37-39, wherein the negotiation data is encrypted according to a key derived from a cleartext connection identifier and a predefined salt number.

Clause 41. The method of clause 37, wherein exchanging the negotiation data includes sending a session description protocol (SDP) offer message indicating support for the QUIC header extension.

Clause 42. The method of any of clauses 37 and 41, wherein exchanging the negotiation data includes receiving a session description protocol (SDP) answer message confirming support for the QUIC header extension.

Clause 43. The method of any of clauses 37-42, wherein exchanging the negotiation data includes sending transport parameters indicating the supported and accepted header extensions.

Clause 44. The method of any of clauses 37-43, wherein the negotiation data includes an SDP attribute quicextmap including an extension name and extension attributes, wherein the quicextmap conforms to ABNF syntax of: Name: quicextmap Value: quicextmap−value Syntax: quicextmap-value=mapentry SP extensionname [SP extensionattributes] mapentry=“quicextmap:” 1*5DIGIT [“/” direction] extensionname=URI extensionattributes=byte-string direction=“sendonly”/“recvonly”/“sendrecv”/“inactive” URI=<Defined in RFC 3986>byte-string=<a byte string, defined in RFC 4566>SP=<the “space” ASCII character>DIGIT=<numbers 0 through 9>.

Clause 45. The method of any of clauses 28-44, wherein the method is performed by a user plane function (UPF) device, the method further comprising: encapsulating the QUIC packet to form a GTP-U tunneled packet; and adding data representing the extracted data to a GTP-U header of the GTP-U tunneled packet.

Clause 46. The method of any of clauses 28-45, wherein the method is performed by a base station device, and wherein using the data from the QUIC header extension comprises performing scheduling for a user equipment (UE) device or adapting behavior of the UE device using the data from the QUIC header extension.

Clause 47. A device for receiving data via a network, the device comprising: a memory configured to store data; and a processing system implemented in circuitry and configured to: receive, during a QUIC communication session, a QUIC packet including a QUIC header extension, the QUIC header extension being unencrypted, the QUIC header extension being separate from a set of flags and a connection identifier (ID) of the QUIC packet; extract data from the QUIC header extension; and use the data from the QUIC header extension to receive data of the QUIC communication session.

Clause 48. A method of transmitting data via a network, the method comprising: generating, for a QUIC communication session, a QUIC packet including a QUIC header extension, the QUIC header extension being unencrypted, the QUIC header extension being separate from a set of flags and a connection identifier (ID) of the QUIC packet; and sending the QUIC packet via the network.

Clause 49. The method of clause 48, wherein the QUIC header extension includes an extension identifier (ID), an extension length, and extension data.

Clause 50. The method of clause 49, wherein the extension length has a value indicating a length of the extension data, the length being a single byte that includes the extension ID and the extension length.

Clause 51. The method of any of clauses 48-50, wherein the QUIC header extension comprises a QUIC header extension of a plurality of QUIC header extensions of the QUIC packet, the method further comprising: encrypting at least one QUIC header extension of the plurality of QUIC header extensions; and adding data to the QUIC header indicating which of the plurality of QUIC header extensions is encrypted or unencrypted in the QUIC packet.

Clause 52. The method of any of clauses 48-51, wherein generating the QUIC packet includes setting an indicator value in a set of reserved bits of a 1-RTT packet header of the QUIC packet to indicate presence of the QUIC header extension.

Clause 53. The method of any of clauses 48-52, further comprising: receiving, before generating the QUIC packet, an initial QUIC packet including a QUIC header extension request frame including a header extension identifier for the QUIC header extension and a definition of the QUIC header extension; and sending an initial QUIC packet response including a QUIC header extension response frame confirming support for the QUIC header extension.

Clause 54. The method of clause 53, wherein the initial QUIC packet including the QUIC header extension request frame and the initial QUIC packet response including the QUIC header extension response frame are encrypted according to a key derived from a cleartext connection identifier and a predefined salt number.

Clause 55. The method of any of clauses 48-54, further comprising exchanging negotiation data representing the QUIC header extension, wherein exchanging the negotiation data includes sending a session description protocol (SDP) offer message indicating support for the QUIC header extension or receiving an SDP answer message confirming support for the QUIC header extension.

Clause 56. The method of any of clauses 48-55, wherein the QUIC header extension includes extension data representing PDU Set information, the PDU Set information including at least one of: PDU Set importance, PDU Set sequence number, PDU Set size, an indication of a start of a PDU Set, or an indication of an end of a PDU Set.

Clause 57. The method of any of clauses 48-56, wherein the QUIC header extension includes extension data representing an idle period indicating a lower bound on a time between a time of transmission of the QUIC packet and a time of transmission of a subsequent QUIC packet.

Clause 58. A device for transmitting data via a network, the device comprising one or more means for performing the method of any of clauses 48-57.

Clause 59. The device of clause 58, wherein the one or more means comprise a memory and a processing system implemented in circuitry.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
receiving, during a QUIC communication session, a QUIC packet including a QUIC header extension, the QUIC header extension being unencrypted, the QUIC header extension being separate from a set of flags and a connection identifier (ID) of the QUIC packet;
extracting data from the QUIC header extension; and
using the data from the QUIC header extension to receive data of the QUIC communication session.

2. The method of claim 1, wherein the QUIC header extension includes an extension identifier (ID), an extension length, and extension data.

3. The method of claim 2, wherein the extension length has a value indicating a length of the extension data, the length being a single byte that includes the extension ID and the extension length.

4. The method of claim 2, wherein the extension length has a value indicating a length of the extension data, the length being two bytes, the two bytes including the extension ID and the extension length.

5. The method of claim 1, wherein the QUIC header extension comprises a QUIC header extension of a plurality of QUIC header extensions of the QUIC packet.

6. The method of claim 5, wherein at least one QUIC header extension of the plurality of QUIC header extensions is encrypted, the QUIC packet further including data indicating which of the plurality of QUIC header extensions is encrypted or unencrypted.

7. The method of claim 1, further comprising determining that the QUIC packet includes the QUIC header extension according to a QUIC version number for the QUIC packet;

8. The method of claim 1, further comprising determining that the QUIC packet includes the QUIC header extension according to an indicator value of the QUIC packet, wherein the QUIC packet comprises a 1-RTT packet, and the indicator value is included in a set of reserved bits of a 1-RTT packet header of the 1-RTT packet.

9. The method of claim 1, wherein the QUIC header extension follows a packet number of the QUIC packet and precedes payload data of the QUIC packet.

10. The method of claim 1, further comprising exchanging negotiation data representing the QUIC header extension before receiving the QUIC packet.

11. The method of claim 10, wherein exchanging the negotiation data includes sending an initial QUIC packet including a QUIC header extension request frame including a header extension identifier for the QUIC header extension and a definition of the QUIC header extension.

12. The method of claim 10, wherein exchanging the negotiation data includes receiving an initial QUIC packet including a QUIC header extension response frame confirming support for the QUIC header extension.

13. The method of claim 10, wherein the negotiation data is encrypted according to a key derived from a cleartext connection identifier and a predefined salt number.

14. The method of claim 10, wherein exchanging the negotiation data includes sending a session description protocol (SDP) offer message indicating support for the QUIC header extension.

15. The method of claim 10, wherein exchanging the negotiation data includes receiving a session description protocol (SDP) answer message confirming support for the QUIC header extension.

16. The method of claim 10, wherein exchanging the negotiation data includes sending transport parameters indicating supported and accepted header extensions.

17. The method of claim 10, wherein the negotiation data includes an SDP attribute quicextmap including an extension name and extension attributes, wherein the SDP attribute quicextmap conforms to ABNF syntax of:
Name: quicextmap
Value: quicextmap−value
Syntax:
quicextmap−value=mapentry SP extensionname [SP extensionattributes]
mapentry=“quicextmap:” 1*5DIGIT [“/” direction]
extensionname=URI
extensionattributes=byte-string
direction=“sendonly”/ “recvonly”/“sendrecv”/“inactive”
URI=<Defined in RFC 3986>
byte-string=<a byte string, defined in RFC 4566>
SP=<the “space” ASCII character>
DIGIT=<numbers 0 through 9>.

18. The method of claim 1, wherein the method is performed by a user plane function (UPF) device, the method further comprising:
encapsulating the QUIC packet to form a GTP-U tunneled packet; and
adding data representing the data extracted from the QUIC header extension to a GTP-U header of the GTP-U tunneled packet.

19. The method of claim 1, wherein the method is performed by a base station device, and wherein using the data from the QUIC header extension comprises performing scheduling for a user equipment (UE) device or adapting behavior of the UE device using the data from the QUIC header extension.

20. A device for receiving data via a network, the device comprising:
a memory configured to store data; and
a processing system implemented in circuitry and configured to:
receive, during a QUIC communication session, a QUIC packet including a QUIC header extension, the QUIC header extension being unencrypted, the QUIC header extension being separate from a set of flags and a connection identifier (ID) of the QUIC packet;
extract data from the QUIC header extension; and
use the data from the QUIC header extension to receive data of the QUIC communication session.
